(19) United States
(12) Patent Application Publication
(10) Pub. No.: US 2025/0211355 A1
(43) Pub. Date: Jun. 26, 2025

(54) SYNCHRONIZED TIME-DIVISION MULTIPLE ACCESS NETWORK FOR OPTIMIZING COMMUNICATION SCHEDULES AND METHOD THEREOF

(71) Applicant: Quasistatics Inc., West Lafayette, IN (US)

(72) Inventors: Robert Tucker Swan, West Lafayette, IN (US); Shovan Maity, West Lafayette, IN (US); Shreyas Sen, West Lafayette, IN (US)

(21) Appl. No.: 18/676,789

(22) Filed: May 29, 2024

Related U.S. Application Data
(60) Provisional application No. 63/614,491, filed on Dec. 22, 2023.

(51) Int. Cl. H04J 3/24

(52) U.S. Cl. CPC H04J 3/247

(57) ABSTRACT

The present disclosure provides a synchronized time division multiple access (TDMA) network is disclosed. The synchronized TDMA network includes computing devices and a central control system. The central control system monitors transmission of data packets between the computing devices and the central control system. The central control system assigns a communication slot to each of the computing devices, for synchronizing the central control system with the computing devices. The central control system determines a communication schedule for each of the computing devices. The communication schedule defines a direction, computing devices involved, and types of data transactions occurring at a predetermined time frame. The central control system transmits a data packet to each of the computing devices at predefined intervals for aligning a timing parameter of communication of each of the computing devices and the central control system.

### CROSS REFERENCE

This Application is based upon and derives the benefit of U.S. Provisional Application No. 63/614,491 filed on Dec. 22, 2023, the contents of which are incorporated herein by reference.

### TECHNICAL FIELD

The present invention relates to communication interfaces, and more particularly relates to a synchronized time-division multiple access (TDMA) network implementing a communication protocol for optimizing communication schedules and a method thereof.

### BACKGROUND

Communication protocols are a set of rules and conventions that govern the exchange of data between devices or systems in a network. The protocols define communication parameters (such as format, timing, sequencing, and error control mechanisms) for exchanging data. Currently, there are numerous communication protocols used in various networking technologies and applications, each designed for specific purposes and requirements. Further, each communication protocol is associated with varying capabilities in terms of latency, throughput, power efficiency, and number of devices supported.

One such example of the communication protocol is the wired communication protocol (as shown in FIG. 1A). The wired communication protocols are designed with medium to very high bitrates. In the wired communication protocol, the transmission and reception power are least significant as the devices are adapted to transmit and receive at any time, as opposed to receiving when needed. Further, the wired communication protocols allow multiple connections to be connected at any time and provide high throughput, and the like. Generally, some wired communication protocol uses a single dominant start of frame (SOF) to synchronize the clock of the receiving device (as shown in FIG. 1A). Further, the receiver is enabled constantly i.e., timing the start of the reception is not a high priority (as shown in FIG. 1A). Furthermore, the host sends the OUT/IN packets to the networked devices to communicate sending/receiving instructions, respectively (as shown in FIG. 1A). Wired communication protocols, while generally reliable, encounter various problems/challenges that affect data transmission and communication efficiency.

Due to the advent of technology, wireless communication protocols have been developed and are being used in various applications for enabling data exchange between devices or systems (as shown in FIG. 1B). Particularly, these protocols enable wireless devices to communicate with each other over radio frequency (RF) signals or other wireless transmission methods. Further, the wireless communication protocol is designed with a low to medium bitrate compared to that of the wired communication protocol. Additionally, receiving and transmitting are much more expensive in wireless, meaning that many protocols were designed to minimize the time of data exchange. Specifically, the transmitter and receiver are triggered at certain instances for facilitating data exchange. As shown in FIG. 1B, the first packet from the master starts the communication during the connection interval for only one slave. Hence, the connection interval is preconfigured for timing the slave to power on the reception. Initially, the master constantly or periodically sends control signals to the slave to instruct the slave regarding the operation to be performed (e.g., data transmission) (as shown in FIG. 1B). Furthermore, the wireless communication protocol allows simultaneous communication with many devices in a single instance. However, with the lower bitrate and more power constraints, the wireless communication protocols fail to effectively support a high number of high throughput devices on the network.

Therefore, there is a need for a network implementing a communication protocol to achieve low latency and low power while maximizing collective data throughput in the network to overcome the aforementioned limitation, in addition to providing other technical advantages.

### SUMMARY

This section is provided to introduce certain objects and aspects of the present disclosure in a simplified form that are further described below in the detailed description. This summary is not intended to identify the key features or the scope of the claimed subject matter.

In an aspect of the present disclosure, a synchronized time division multiple access (TDMA) network is disclosed. The synchronized time division multiple access (TDMA) network includes a plurality of computing devices and a central control system communicably coupled to the plurality of computing devices. The central control system includes a memory storing executable instructions and a processor operatively coupled with the memory. The processor is configured to execute the executable instructions to cause the central control system to at least monitor transmission of data packets between the plurality of computing devices and the central control system in the synchronized time division multiple access (TDMA) network. The central control system is caused to assign a communication slot to each of the plurality of computing devices for synchronizing the central control system with the plurality of computing devices in the synchronized TDMA network. Further, the central control system is caused to determine a communication schedule for each of the plurality of computing devices upon establishing the synchronization between the central control system and the plurality of computing devices. The communication schedule defines a direction, computing devices involved, and types of data transactions occurring at a predetermined time frame. The central control system is further caused to transmit a data packet to each of the plurality of computing devices at predefined intervals for aligning a timing parameter of communication between each of the plurality of computing devices and the central control system in the synchronized TDMA network. The data packet is transmitted via body communicated signals to each of the plurality of computing devices based at least on a device address associated with each of the plurality of computing devices.

In another aspect of the present disclosure, a method performed by a synchronized time division multiple access (TDMA) network is disclosed. The method includes monitoring, by a processor, transmission of data packets between a plurality of computing devices and a central control system in the synchronized TDMA network. The method includes assigning, by the processor, a communication slot to each of the plurality of computing devices for synchronizing the central control system with the plurality of computing devices in the synchronized TDMA network. Further, the method includes determining, by the processor, a communication schedule for each of the plurality of computing devices upon establishing the synchronization between the central control system and the plurality of computing devices. The communication schedule defines a direction, computing devices involved, and types of data transactions occurring at a predetermined time frame. The method further includes transmitting, by the processor, a data packet to each of the plurality of computing devices at predefined intervals to align a timing parameter associated with communication of each of the plurality of computing devices and the central control system in the synchronized TDMA network. The data packet is transmitted via body communicated signals to each of the plurality of computing devices based at least on a device address associated with each of the plurality of computing devices.

In yet another aspect of the present disclosure, a computer program product including a sequence of instructions stored in a non-transitory computer-readable medium, executable by at least one processor causes the at least one processor to perform a method including monitoring transmission of data packets between a plurality of computing devices and a central control system in a synchronized TDMA network. The method includes assigning a communication slot to each of the plurality of computing devices for synchronizing the central control system with the plurality of computing devices in the synchronized TDMA network. Further, the method includes determining a communication schedule for each of the plurality of computing devices upon establishing the synchronization between the central control system and the plurality of computing devices. The communication schedule defines a direction, computing devices involved, and types of data transactions occurring at a predetermined time frame. The method further includes transmitting a data packet to each of the plurality of computing devices at predefined intervals for aligning a timing parameter of communication between each of the plurality of computing devices and the central control system in the synchronized TDMA network. The data packet is transmitted via body communicated signals to each of the plurality of computing devices based at least on a device address associated with each of the plurality of computing devices.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1A-B illustrates an example representation of a communication protocol known in the art, according to prior art;

FIG. 2 illustrates an example representation of an environment depicting a synchronized time-division multiple access (TDMA) network, in accordance with an embodiment of the present disclosure;

FIG. 3 illustrates an example representation of a communication protocol of the synchronous TDMA network of FIG. 2, in accordance with an embodiment of the present disclosure;

FIG. 4 illustrates an example representation of a use case related to auto acknowledgments, in accordance with an embodiment of the present disclosure;

FIGS. 5A, 5B, 5C, 5D, 5E, 5F, and 5G illustrates example representations of types of data transactions associated with the synchronous TDMA network as shown in FIG. 2, in accordance with an embodiment of the present disclosure;

FIG. 6 illustrates a flow diagram of an exemplary method performed by a synchronized time division multiple access (TDMA) network of FIG. 2, in accordance with an embodiment of the present disclosure; and

FIG. 7 illustrates a simplified block diagram representation of an electronic device, in accordance with an embodiment of the present disclosure.

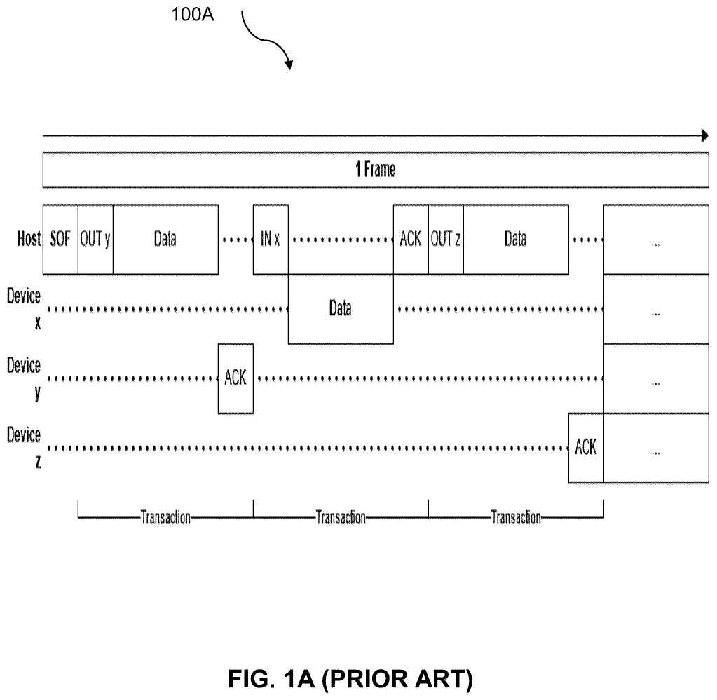

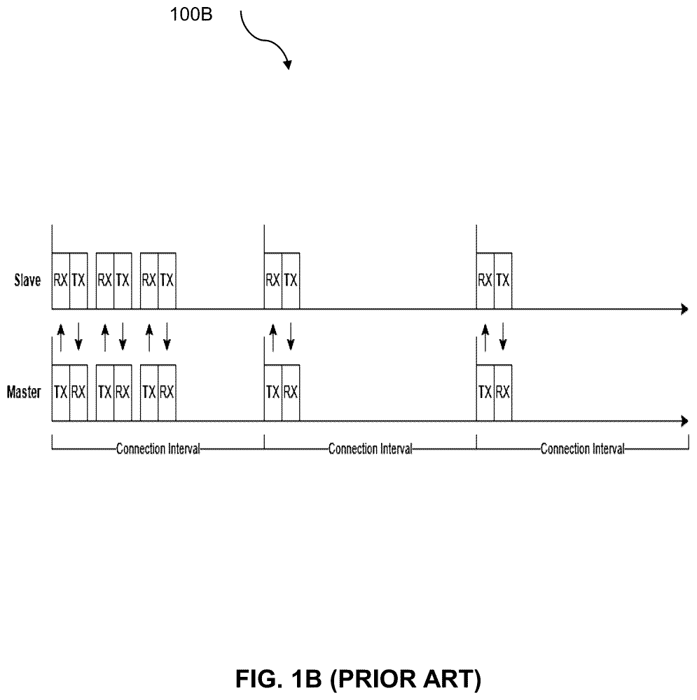

The drawings referred to in this description are not to be understood as being drawn to scale except if specifically noted, and such drawings are only exemplary in nature.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments. The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment”, “in an exemplary embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client, or server, or computer-implemented system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

The present disclosure provides a synchronized Time-Division Multiple Access (TDMA) network. In this embodiment, computing devices periodically synchronize to a central control system to ensure efficient channel utilization and avoid collisions. Packet-based Communication: Data is transmitted in short packets with minimal delay between the computing devices, similar to wired communication. Some features of the present disclosure are as follows: a) Efficient multiplexing: the synchronized TDMA network supports a large number of devices by dynamically allocating communication slots based on demand, b) Hardware-Accelerated Auto-Acknowledgments: the computing devices automatically respond to received packets, minimizing idle time and power consumption, and c) Diverse Transaction Types: Different transaction types, such as, but not limited to, data transfers, acknowledgements, and handshakes, optimize the communication flow for different scenarios.

Further, the present disclosure provides multiple advantages and technical effects such as, a) low latency, b) high throughput: the synchronized TDMA network efficiently utilizes the communication channel, supporting a large amount of data transmission, c) power efficiency: the computing devices are active during their allocated communication slots, minimizing power consumption, and d) scalability: the synchronized TDMA network may support many devices in a body area network (BAN) without compromising performance of the computing devices.

Various applications are envisioned with the communication protocol associated with the synchronized TDMA network. Some exemplary applications are as follows: 1) On-body Sensors: enables communication between sensors worn on the human body, such as, but not limited to, for health monitoring or fitness tracking, 2) Mobile Media Streaming: The low latency and high throughput enables streaming multimedia content between the computing devices, and 3) room-based networks or car-internal communication.

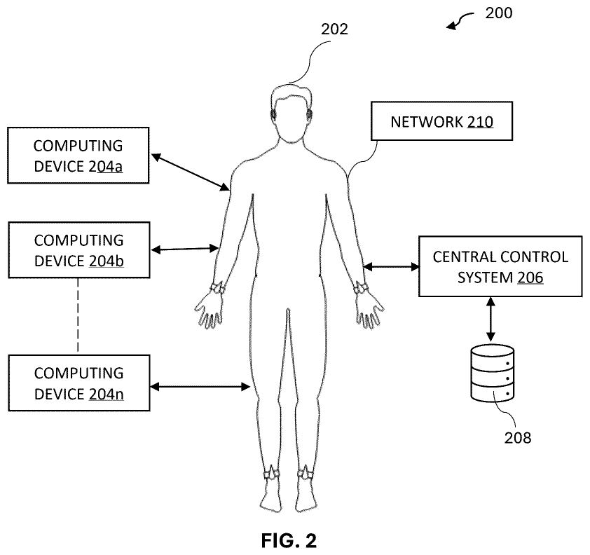

Referring now to the drawings, and more particularly to FIG. 2 through FIG. 7, where similar reference characters denote corresponding features consistently throughout the figures, there are shown preferred embodiments and these embodiments are described in the context of the following exemplary system and/or method.

FIG. 2 illustrates an example representation of an environment 200 depicting a synchronized time-division multiple access (TDMA) network, in accordance with an embodiment of the present disclosure. Although the environment 200 is presented in one arrangement, other arrangements are also possible where the parts of the environment 200 (or other parts) are arranged or interconnected differently. The environment 200 is interchangeably referred to as ‘the synchronized time-division multiple access (TDMA) network 200’. In general, the synchronized TDMA network 200 implements a communication protocol for maximizing collective data throughput in the synchronized TDMA network 200.

The environment 200 includes a user 202, a plurality of computing devices 204 (collectively referred to a computing device 204a, a computing device 204b, . . . a computing device 204n), and a central control system 206. The central control system 206 is capable of connecting to a communication network, such as the network 210, for communicating with the computing devices 204. Some non-limiting examples of the computing devices 204 may include, smartwatches, health and fitness trackers, wearable headsets, or any other computing device. The plurality of computing devices 204 may be referred to as ‘node devices’ and the central control system 206 may be referred to as ‘hub system’. The central control system 206) 206 may be a master and the node devices 204 within the synchronized TDMA network 200 may be slaves. In the preferred embodiment, communication is established across the synchronized TDMA network 200 between various devices (i.e., the computing devices 204), using a communication protocol which will be explained further in detail.

Further, the central control system 206 includes at least one processor and a memory (not shown in FIG. 2) storing executable instructions. The processor is configured to execute the executable instructions to cause the central control system 206 to at least perform one or more operations described herein. The central control system 206 monitors data packets of the plurality of computing devices 204. In other words, the central control system 206 monitors the data packets (e.g., transmission control protocol (TCP) packets) received at or transmitted from the computing devices 204. Thereafter, the central control system 206 assigns a communication slot to each of the plurality of computing devices 204 in the synchronized TDMA network 200. This establishes a synchronization between the central control system 206 and the plurality of computing devices 204 in the synchronized TDMA network 200.

Thereafter, the central control system 206 determines a communication schedule for each computing device of the plurality of computing devices 204 upon establishing the synchronization between the central control system 206 and the plurality of computing devices 204. The communication schedule defines one of a direction, computing devices involved, types of data transactions occurring at a predetermined time frame, and the like. For example, the types of data transactions may include, for example, but not limited to, data transfers, acknowledgment, handshakes, and communication flow.

Further, the central control system 206 transmits a data packet to each of the plurality of computing devices 206 at predefined intervals (or regular intervals). In this scenario, the data packet may be a synchronization data packet. Hence, the data packet being transmitted to the plurality of computing devices 204 aligns a timing parameter associated with the communication of each of the plurality of computing devices 204 and the central control system 206 in the synchronized TDMA network 200. In other words, the synchronization data packet sent by the central control system 206 is used to start the sequence of communication for each of the plurality of computing devices 204. Moreover, the central control system 206 transmits the synchronization data packet to a corresponding computing device (e.g., a computing device 204a) at a start frame of a predefined time period. The start frame of the predefined time period may be defined based on occurrence of the communication of the defined communication schedule.

In one scenario, the data packet (or the synchronization data packet) is transmitted to each of the plurality of computing devices 204 via body communicated signals (i.e., the communication protocol). The data may be transmitted in short packets with minimal delay between the plurality of computing devices 204 via the body-communicated signals. In particular, the central control system 206 with access to a device address associated with each of the plurality of computing devices 204 transmits the data packet to the respective computing device of the plurality of computing devices 204. The device address may be for example, an address in a typical way in electronics. Essentially a numerical, alpha-numeric, or similar type of address which identifies a single device or function on the network. In an example embodiment, the data packet for synchronization is to be transmitted to the computing device 204a among the plurality of computing devices 204. In this scenario, the central control system 204 accesses the device address of the computing device 204a for transmitting the data packet to the computing device 204a. Thus, the synchronization slot (or the communication slot) creates a tightly synchronized time multiplexed network with the body communicated signals.

In another scenario, the communication between the plurality of computing devices 204 and the central control system 206 is established using Electro-Quasistatic (EQS) communication on a conductive medium. It is known that water filled with conductive particles such as electrolytes and salts conducts electricity better. The human body is filled with a watery solution called the interstitial fluid that sits underneath the skin and around the cells of the body. The interstitial fluid is responsible for carrying nutrients from the bloodstream to the body's cells, and is filled with proteins, salts, sugars, hormones, neurotransmitters, and all sorts of other molecules that help keep the body going. As a result, the interstitial fluid in the user's body (i.e., the user 202) allows the establishment of a circuit between two or more communicating devices (computing devices 204 and the central control system 206) located anywhere on/around the body. Further, the synchronized TDMA network 200 may be a network infrastructure that protects the confidentiality, integrity, and availability of data transmitted between connected devices (i.e., the computing devices 204 and the central control system 206).

In both the scenarios, the human body (i.e., the user 202) is used as a broadband (BB) channel for data transmission as explained above. A broadband channel with-MHz bandwidth can enable data transmission at megabits/second speed which is sufficient for applications such as image or data transfer. Hence, the user's body (i.e. the user 202) may be referred to as a human body communication (HBC) system. Thus, for enabling data transmission using the body communicated signals, the human body communication system may include a transmitting electrode (not shown in Figures) and a receiving electrode (not shown in Figures). The receiving electrode may be placed adjacent or slightly separated from the skin of the user 202 and associated with the lower tissue of the skin. It is apparent that there is no common ground, or no closed path for current to flow. However, the closed path is formed using parasitic capacitances from the computing devices 204 and the central control system 206 to the earth's ground. The parasitic capacitances may be referred to as the capacitive HBC. The formation of the parasitic capacitances forms a closed circuit, thus enabling data transmission between the computing devices 204 and the central control system 206 through the low-resistance tissue layers inside the body.

In yet another scenario, the communication between the plurality of computing devices 204 and the central control system 206 is established using a resonant communication on a conductive medium.

The central control system 206 is further configured to verify the data packet to be transmitted to the plurality of computing devices 204 in the synchronous TDMA network 200. The central control system 206 is associated with a database 208 configured to store a set of validation rules. In an example, the central control system 206 may use artificial intelligence or machine learning based validation techniques for validating the data packet. Thereafter, the central control system 206 transmits an acknowledgment response to the plurality of computing devices 204. The acknowledgment response may include, for example, but not limited to, a verification status of the data packet.

In an example embodiment, verification is typically expected to be performed using common techniques such as CRC checks, checking any IDs within the packet, or other techniques such as outputs from ECCs. Acknowledgements may be a short packet sent by the receiving device with proper identifying information so that the sending device knows that the packet has been received without error.

The central control system 206 may facilitate scheduling the transfer of the data packet to the plurality of computing devices 204. For example, the central control system 206 may queue transfers of the data packet ahead of time. This provides a buffer time to the computing devices 204 to prepare for a transfer ahead of time.

Additionally, the synchronous TDMA network 200 supports a large number of devices by dynamically allocating communication slots as per the requirements. In particular, the central control system 206 facilitates multiplexing of the communication slot associated with the plurality of computing devices 204 in the synchronous TDMA network 200. For example, the synchronous TDMA network 200 may facilitate at least 30 devices (such as the computing devices 204) to be able to communicate in the synchronous TDMA network 200 with the body communicated signals. Further, the communication multiplexing of the communication slot allows the plurality of computing devices to communicate in the synchronous TDMA network 200. Specifically, communication multiplexing allows transmission of multiple signals simultaneously over a shared medium or channel i.e., the synchronized TDMA network 200. As such, by multiplexing multiple signals, the available bandwidth may be utilized more efficiently, thus increasing the throughput of the communication link i.e., the synchronized TDMA network 200.

Further, the central control system 206 is configured to perform a periodic connection survey of each of the plurality of computing devices 204 in the synchronous TDMA network 200. The periodic connection survey refers to a communication survey for fetching feedback and insights from the plurality of computing devices 204 about the communication within the synchronized TDMA network 200. Based on the connection survey, the central control system 206 identifies a computing device among the plurality of computing devices 204 that is disconnected from the synchronous TDMA network 200. For instance, the computing device 204a may be disconnected from the synchronous TDMA network 200. In this scenario, the central control system 206 establishes a communication link between the identified computing device 204a and the synchronous TDMA network 200. The periodic survey allows the computing devices 204 to be synchronized in the synchronous TDMA network 200 thus resulting in efficient channel utilization and avoiding collisions.

Furthermore, the central control system 206 is configured to identify new devices on the user's body (i.e. the user 202) and configure automatic arbitration of a new optimum schedule. In other words, the central control system 206 configures the communication schedule to adjust each of the plurality of computing devices 204 on the synchronous TDMA network 200 to establish a new communication link in the synchronous TDMA network 200. In an example embodiment, the device may send out packets which indicates that it is available to add to its network or available to be added to a network. The devices may then go through a handshake to ensure that the devices have the correct information and that the new device may be added to the network. This handshake may be a sequence of packets back and forth until the connection is rejected or completed. Once complete, the device may be able to operate in the network and continue regular operations.

In an embodiment, the communication protocol associated with the synchronous TDMA network 200 is suitable for, but not limited to, on-body applications (or on-body sensors) or mobile media streaming or the like. In another embodiment, the communication protocol may be suitable for other applications such as a room that shares a network, or a car that may communicate within itself using this low-power protocol. These different applications may be using different forms of EQS or resonant communication.

The number and arrangement of systems, devices, and/or networks shown in FIG. 2 are provided as an example. There may be other systems, devices, and/or networks; fewer systems, devices, and/or networks; different systems, devices, and/or networks, and/or differently arranged systems, devices, and/or networks than those shown in FIG. 2.

Though few components and subsystems are disclosed in FIG. 2, there may be additional components and subsystems which is not shown, such as, but not limited to, ports, routers, repeaters, firewall devices, network devices, databases, network attached storage devices, user devices, additional processing systems, servers, assets, machineries, instruments, facility equipment, any other devices, and combination thereof. The person skilled in the art should not be limiting the components/subsystems shown in FIG. 2.

Those of ordinary skilled in the art will appreciate that the hardware depicted in FIG. 2 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

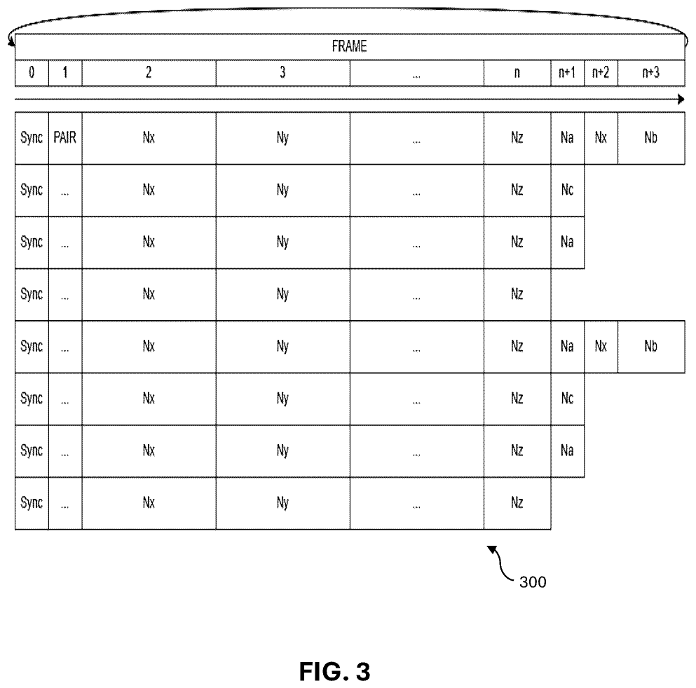

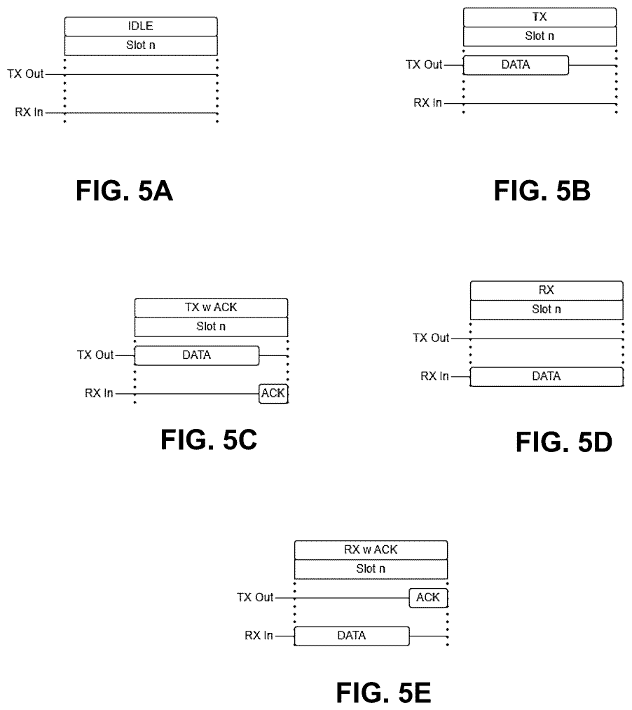

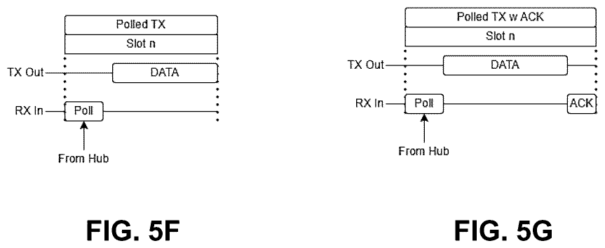

FIG. 3 illustrates an example representation of a communication protocol 300 of the synchronous TDMA network 200 of FIG. 2, in accordance with an embodiment of the present disclosure. The communication protocol 300 is an example of the body area network communication protocol. As explained above, the computing devices 204 are periodically synchronized and are allowed to communicate multiple times in each frame. Further, the computing devices 204 are capable of pairing in the synchronized TDMA network 200 and interleave packets at different time frames as defined in the communication schedule. In this FIG. 3, there is a network with a number of devices which are communicating. Each row represents a frame and within a frame there are a number of slots, at least one of which is used to synchronize the devices on the network. Within each slot a transaction may occur between 0 to N devices. These transactions include but are not limited to the items in FIG. 5. Altogether, this sequence of transactions in the sequence of frames represent an example of the TDMA network operating with a number of devices.

As shown, the communication signal ‘Sync’ is transmitted by the central control system 206 to the computing devices 204. In other words, sync corresponds to transmission of the synchronization data packet as explained above. The central control system 204 transmitting ‘sync’ initiates the sequence of communications for each of the computing devices 204 (exemplarily represented as nodes (Nx, Ny, . . . )). As explained above, the synchronization data packet aligns the timing parameter associated with the communication of each of the computing devices 204 and the central control system 206 in the synchronized TDMA network 200. In other words, the computing devices 204 are notified of the time frame to communicate at times relative to receiving the ‘Sync’. Hence, sync is used for timing the transactions. In general, the timing parameter in synchronization defines the timing relationships and requirements necessary for proper operation and coordination of the plurality of computing devices 204 within the synchronized TDMA network 200. Further, the receiver (or the computing devices 204) is not triggered constantly based on the communication schedule.

Moreover, in the case of sending/receiving, the communication schedule is configured to trigger the computing devices 204 in the corresponding communication slot (exemplarily represented as 0, 1, . . . , n+2, n+3) for sending or receiving or performing multiple communications during that time. It is to be noted that the synchronization data packet (or ‘sync’) is for each of the computing devices 204 (or nodes). Hence, the central control system 206 may not transmit the data packet (or the synchronization data packet) for each of the computing devices 204 (or for each node) that the central control system 206 communicates with. In an embodiment, the communication type may be either sending, receiving, or a combination as explained above.

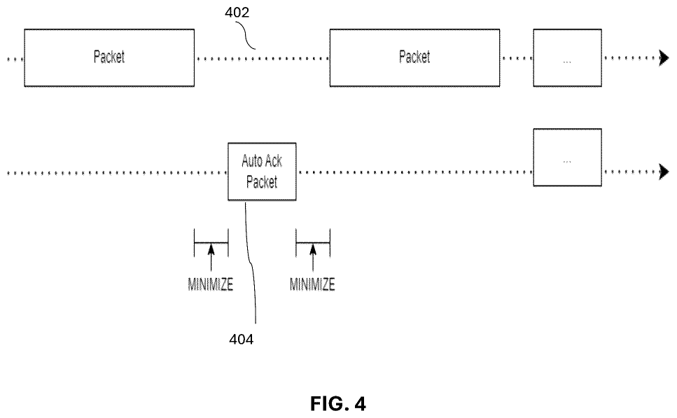

FIG. 4 illustrates an example representation of a use case related to auto acknowledgments, in accordance with an embodiment of the present disclosure. In the case of receiving the data packets (see, 402 of FIG. 4), a computing device (e.g., the computing device 204b) may automatically respond to the data packets that are addressed to the computing device 204b. In an embodiment, the computing devices 204b may include specific hardware/logic to transmit an auto acknowledgment response (see, 404 of FIG. 4).

FIGS. 5A-5G illustrate example representations of types of data transactions associated with the synchronous TDMA network 200 of FIG. 2, in accordance with an embodiment of the present disclosure. The types of data transactions shown in FIGS. 5A-5G allow the communication to have different types of transaction which the hardware assists in maximizing communication link utilization. In other words, the combination of the different types of data transactions allows high channel utilization, establishing multiple computing devices on the synchronous TDMA network 200, power efficiency, and low latency.

Referring to FIG. 5A, a device (for example, the computing devices 204a) within the synchronous TDMA network 200 is idle and operates in power saving mode i.e. does not restrict other devices (for example, the computing devices 204b-204n) from operating at this time.

Referring to FIG. 5B, a device (for example, the computing devices 204a) is sending a packet(s) to 0-N devices (for example, the computing devices 204b-204n) without the requirement of an acknowledgment for the packet(s). In this scenario, the operation performed by the other computing devices (for example, the computing devices 204b-204n) with reference to FIG. 5B corresponds to the operation performed by the other computing devices (for example, the computing devices 204b-204n) as shown in FIG. 5D.

Referring to FIG. 5C, a device (for example, the computing devices 204a) is sending a packet(s) to 0-N devices (for example, the computing devices 204b-204n) and expecting an acknowledgment for the packet(s). In this scenario, the operation performed by the other computing devices (for example, the computing devices 204b-204n) with reference to FIG. 5C corresponds to the operation performed by the other computing devices (for example, the computing devices 204b-204n) as shown in FIG. 5E.

Referring to FIG. 5D, a device (for example, the computing devices 204a) is expecting to receive packet(s) without acknowledgement. In this scenario, the operation performed by the other computing devices (for example, the computing devices 204b-204n) with reference to FIG. 5D corresponds to the operation performed by the other computing devices (for example, the computing devices 204b-204n) as shown in FIG. 5B.

Referring to FIG. 5E, a device (for example, the computing devices 204a) is expecting to receive packet(s) and reverts with acknowledgement. In this scenario, the operation performed by the other computing devices (for example, the computing devices 204b-204n) with reference to FIG. 5E corresponds to the operation performed by the other computing devices (for example, the computing devices 204b-204n) as shown in FIG. 5C.

Referring to FIG. 5F, a device (for example, the central control system 206) transmits a polling packet to indicate the device(s) (for example, the computing devices 204a-204n) to perform the operations as explained with references to FIG. 5B or FIG. 5D.

Referring to FIG. 5G, a device (for example, the central control system 206) transmits a polling packet to indicate the device(s) (for example, the computing devices 204a-204n) to perform the operations as explained with references to FIG. 5C or FIG. 5E.

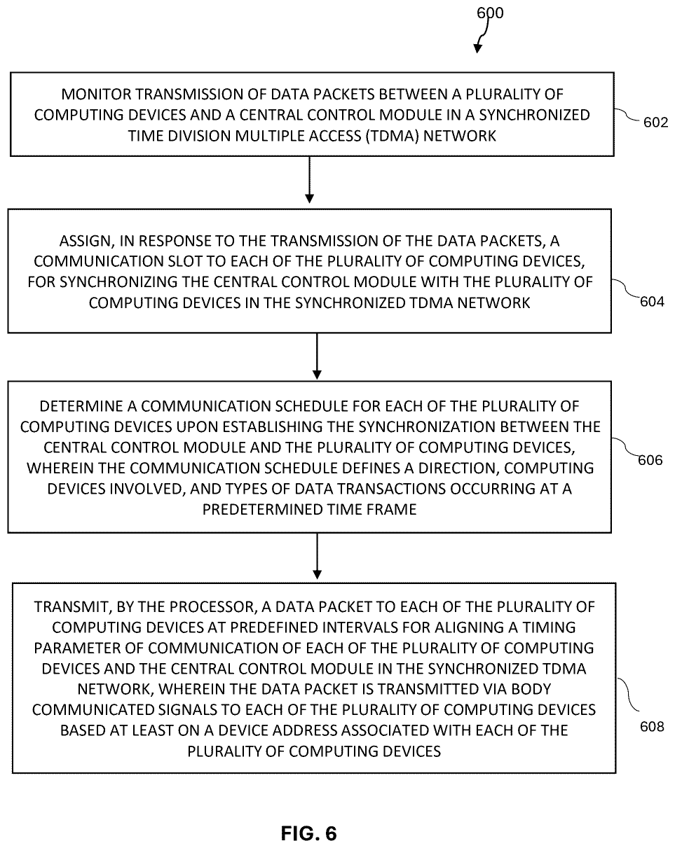

FIG. 6 illustrates a flow diagram of a method 600 performed by a synchronized time division multiple access (TDMA) network 200 of FIG. 2, in accordance with an embodiment of the present disclosure. The method 600 depicted in the flow diagram may be executed by, for example, the processor of the central control system 206. The method 600 starts at operation 602.

At operation 602, the method 600 includes monitoring, by a processor, transmission of data packets between the plurality of computing devices 204 and the central control system 206 of the synchronized TDMA network 200. For example, a device may be operating as the hub/central and may be polling for new device or looking for devices which are polling for networks.

At operation 604, the method 600 includes in response to the transmission of the data packets, assigning, by the processor, a communication slot to each of the plurality of computing devices 204 for synchronizing the central control system 206 with the plurality of computing devices 204 in the synchronized TDMA network 200. Through a sequence of requests the devices may negotiate a location within the network based on the requirements from the connecting device and the capabilities/restrictions of the hub/central.

At operation 606, the method 600 includes determining, by the processor, a communication schedule for each of the plurality of computing devices upon establishing the synchronization between the central control system 206 and the plurality of computing devices 204. The communication schedule defines a direction, computing devices involved, and types of data transactions occurring at a predetermined time frame. From the negotiations, the connecting device may be assigned location(s) in the network for its transactions to occur. The network may then proceed to operate with the connected devices with the configured network using body communicated signals to transfer requests and run the applications of the devices connected on the network.

At operation 608, the method 600 includes transmitting, by the processor, a data packet to each of the plurality of computing devices 204 at predefined intervals for aligning a timing parameter of communication of each of the plurality of computing devices 204 and the central control system 206 in the synchronized TDMA network 200. The data packet is transmitted via body communicated signals to each of the plurality of computing devices 204 based at least on a device address associated with each of the plurality of computing devices 204. The one or more operations performed by the synchronous TDMA network 200 are already explained with references to FIG. 2 to FIGS. 5A-5G, and therefore they are not reiterated, for the sake of brevity.

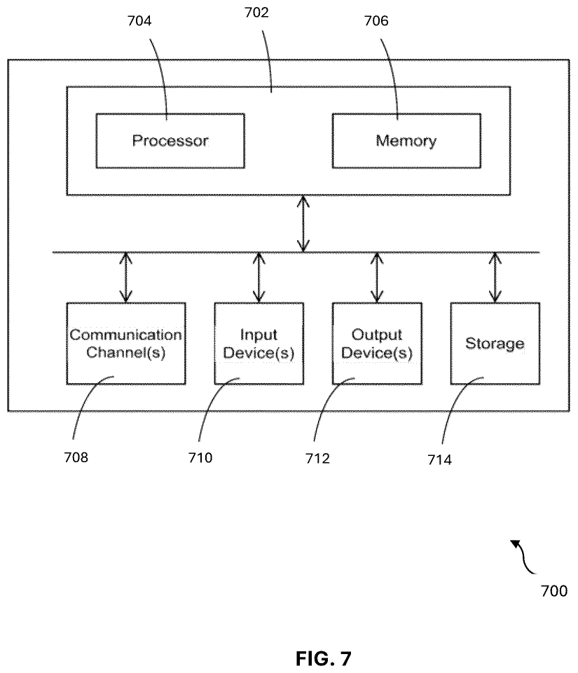

FIG. 7 illustrates a simplified block diagram representation of an electronic device 700, in accordance with an embodiment of the present disclosure. The electronic device 700 is the example of the computing devices 204 and the central control system 206. The electronic device 700 includes a computer system 702. The computer system 702 includes one or more processors 704 and at least one memory 706. The processor 704 is configured to execute program instructions. For example, the processor 704 may be a real processor or a virtual processor. It will be understood that the computer system 702 does not suggest any limitation as to the scope of use or functionality of the described embodiments. The computer system 702 may include, but is not limited to, one or more of a general-purpose computer, a programmed microprocessor, a microcontroller, an integrated circuit, digital signal processors (DSPs), field-programmable gate arrays (FPGAs), and application-specific integrated circuits (ASICs) and other devices or arrangements of devices that are capable of implementing the steps that constitute the methods of the present invention.

Exemplary embodiments of the computer system 702 in accordance with the present invention may include one or more servers, desktops, laptops, tablets, smartphones, mobile phones, mobile communication devices, tablets, phablets, and personal digital assistants. In an embodiment, the memory 706 may store software for implementing various embodiments of the present invention. The computer system 702 may include additional components or fewer components. For example, the computer system 702 may include one or more communication channels 708, one or more input devices 710, one or more output devices 712, and a storage 714. An interconnection mechanism (not shown) such as a bus, control circuitry, or network, interconnects the components of the computer system 702. In various embodiments, operating system software (not shown) provides an operating environment for various software(s) executing in the computer system 702 using a processor 704 and manages different functions and features of the components of the computer system 702.

The communication channel(s) 708 is an example of the communication network 210. The communication channel(s) 708 allows communication over a communication medium to various other computing entities. The communication medium provides information such as program instructions, or other data in a communication medium. The communication media may include, but are not limited to, wired or wireless methodologies implemented with electrical, optical, RF, infrared, acoustic, microwave, Bluetooth, IEEE 802.15.6, IEEE 802.15.4, IEEE 802.15.3 compliant networking protocols, or other transmission media.

The input device(s) 710 may include, but are not limited to, a touch screen, a keyboard, mouse, pen, joystick, trackball, a voice device, a scanning device, or any other device that is capable of providing input to the computer system 702. In an embodiment of the present invention, the input device(s) 710 may be a sound card or similar device that accepts audio input in analog or digital form. The output device(s) 712 may include, but not be limited to, a user interface on CRT, LCD, LED display, or any other display associated with any of servers, desktops, laptops, tablets, smartphones, mobile phones, mobile communication devices, tablets, phablets and personal digital assistants, printer, speaker, CD/DVD writer, or any other device that provides output from the computer system 702.

The storage 714 may include, but not be limited to, magnetic disks, magnetic tapes, CD-ROMs, CD-RWs, DVDs, any types of computer memory, magnetic stripes, smart cards, printed barcodes, or any other transitory or non-transitory medium which can be used to store information and can be accessed by the computer system 702. In various embodiments, the storage 714 may contain program instructions for implementing any of the described embodiments.

In an embodiment, the computer system 702 is part of a distributed network or a part of a set of available cloud resources.

In an embodiment, the present invention may be applicable to any such wearable compute apparatus, including a plurality of sensors, but whose processing power is in a separate computing device near the device in a body area network. To further illustrate, the utility advantage of this implementation is that the wearable device becomes as lightweight as it does.

The present invention may be implemented in numerous ways including as a system, a method, or a computer program product such as a computer readable storage medium or a computer network wherein programming instructions are communicated from a remote location.

In some aspects, the present invention may suitably be embodied as a computer program product for use with the computer system 702. The method described herein is typically implemented as a computer program product, comprising a set of program instructions that is executed by the computer system 702 or any other similar device. The set of program instructions may be a series of computer-readable codes stored on a tangible medium, such as a computer readable storage medium (i.e., the storage 714), for example, diskette, CD-ROM, ROM, flash drives or hard disk, or transmittable to the computer system 702, via a modem or other interface device, over either a tangible medium, including but not limited to optical or analogue communications channel(s) 708. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

The present disclosure solves the problem of optimizing the communication schedule of the computing devices by implementing a communication protocol in a communication network to minimize power consumption and increase high throughput.

Further, the communication protocol (e.g., Wi-R utilized body-communicated signals) in a body area network enabling the broadband behavior to result in the communication acting like a lossy wire. However, there is no physical wire connecting between the computing devices and the central control system. Since both the wired and wireless communication protocols provide different pros, cons, and considerations the goal for body-communicated signals a protocol that maximizes the pros given its capabilities is to be selected. The desirable capabilities of wired communication are low latency, high throughput, high utilization of communication links, and potentially high number of devices. The desirable capabilities of wireless communication are communication to multiple devices at a time and reception only when necessary. Therefore, there is a need to create a new protocol that is optimized for the pros of both wireless and wired communication. In order to overcome the above-limitation, various embodiments of the present invention offer multiple advantages and technical effects. Without limiting the scope of the invention, the present disclosure discloses the synchronous TDMA network 200 implementing a communication protocol designed for body area networks (BANs). The communication protocol of the synchronous TDMA network 200 provides low latency, maximizing collective data throughput by efficiently utilizing the communication channel, support a large amount of data transmission, increased power efficiency based on optimized communication schedule and scalability without compromising the performance.

The present disclosure provides a novel communication protocol specifically designed for body area networks (BANs) utilizing “body-communicated signals”. These signals offer unique characteristics similar to both wired and wireless communication, with different advantages.

In Synchronized Time-Division Multiple Access (TDMA), the devices periodically synchronize to ensure efficient channel utilization and avoid collisions. In Packet-based Communication, Data is transmitted in short packets with minimal delay between them. The network supports a large number of devices by dynamically allocating communication slots based on demand. Further, the devices automatically respond to received packets, minimizing idle time and power consumption. Different transaction types, such as data transfers, acknowledgements, and handshakes, optimize the communication flow for different scenarios.

In the present disclosure, data transfer is fast and reliable with minimal delay. The network efficiently utilizes the communication channel, supporting a large amount of data transmission. Devices are only active during their allocated communication slots, minimizing power consumption. The protocol of the present disclosure may support many devices in a BAN without compromising performance.

The present disclosure may be applicable to many on-body sensors. This protocol is ideal for communication between sensors worn on the body, such as for health monitoring or fitness tracking. Further, the present disclosure may be applicable to many mobile media streaming: The low latency and high throughput make it suitable for streaming multimedia content between devices on the body. The protocol's flexibility may be adapted for other applications like room-based networks or car-internal communication. Overall, this present disclosure presents a novel and efficient communication protocol tailored for body area networks utilizing the unique properties of body-communicated signals. Its low latency, high throughput, power efficiency, and scalability make it a promising solution for various on-body and beyond-BAN applications.

In this body communicated network, the devices communicate with packets that have minimized duration between and synchronization capabilities to maximize channel utilization. Additionally, the devices may efficiently multiplex the network to allow for support of many devices. The devices on the network have a set time to communicate, allowing the receivers to be enabled only when expecting communication. Within these communications, the network takes advantage of hardware optimized communication to efficiently transfer data between devices. One method which helps to efficiently facilitate communication is auto acknowledgments, as seen in FIG. 4. In addition to auto acknowledgements, the devices use different transaction types to schedule the communication on the network. Some of these can be seen in FIGS. 5A-G. The combination of these capabilities allows for high channel utilization, many devices on the network, power efficiency, and low latency, capabilities that lend well to on body communicated signals for body area networks.

While this protocol has capabilities great for on body applications, it also lends itself well to other entities. Some examples may include a room which shares a network, or a car which can communicate within itself using this low power protocol. These different applications may be using different forms of EQS or resonant communication to accomplish this, however the capabilities of this protocol lend themselves to those applications

Although a preferred embodiment of the present invention has been described for illustrative purposes, those skilled in the art will appreciate that various modifications, additions and substitutions are possible, without departing from the scope and spirit of the invention as disclosed in the accompanying claims. Such alterations are herewith anticipated.

One of the ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, a. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, and the like., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

What is claimed is:

1. A synchronized time division multiple access (TDMA) network, comprising:
a plurality of computing devices; and
a central control system communicably coupled to the plurality of computing devices, the central control system comprising:
a memory storing executable instructions, and
a processor operatively coupled with the memory, the processor configured to execute the executable instructions to cause the central control system to at least:
monitor transmission of data packets between the plurality of computing devices and the central control system in a synchronized time division multiple access (TDMA) network,
in response to the transmission of the data packets, assign a communication slot to each of the plurality of computing devices for synchronizing the central control system with the plurality of computing devices in the synchronized TDMA network,
determine a communication schedule for each of the plurality of computing devices upon synchronizing the central control system with the plurality of computing devices, wherein the communication schedule defines a direction, computing devices, and types of data transactions occurring at a predetermined time frame, and
transmit a data packet to each of the plurality of computing devices at predefined intervals for aligning a timing parameter of communication between each of the plurality of computing devices and the central control system in the synchronized TDMA network,
wherein the data packet is transmitted via body communicated signals to each of the plurality of computing devices based at least one of a device address associated with each of the plurality of computing devices.

2. The synchronous TDMA network of claim 1, wherein the communication between the plurality of computing devices and the central control system is established using Electro-Quasistatic (EQS) communication on a conductive medium.

3. The synchronous TDMA network of claim 1, wherein the communication between the plurality of computing devices and the central control system is established using resonant communication on a conductive medium.

4. The synchronous TDMA network of claim 1, wherein the data packet is transmitted to a corresponding computing device of the plurality of computing devices at a start frame of a predefined time period of occurrence of the communication defined in the communication schedule.

5. The synchronous TDMA network of claim 1, wherein the types of data transactions comprise data transfers, acknowledgment, handshakes, and communication flow.

6. The synchronous TDMA network of claim 1, wherein the processor is further configured to:
verify the data packet to be transmitted to the plurality of computing devices in the synchronous TDMA network; and
in response to successful verification of the data packet, transmit an acknowledgment response to the plurality of computing devices, wherein the acknowledgment response comprises a verification status of the data packet.

7. The synchronous TDMA network of claim 1, wherein the processor is further configured to:
multiplex the communication slot associated with the plurality of computing devices in the synchronous TDMA network to allow the plurality of computing devices to communicate in the synchronous TDMA network.

8. The synchronous TDMA network of claim 1, wherein the processor is further configured to:
perform a periodic connection survey of each of the plurality of computing devices in the synchronous TDMA network to identify a computing device among the plurality of computing devices determined to be disconnected from the synchronous TDMA network; and
upon identifying the computing device, establish a communication link between the identified computing device and the synchronous TDMA network.

9. The synchronous TDMA network of claim 1, wherein the processor is further configured to:
configure the communication schedule to adjust each of the plurality of computing devices on the synchronous TDMA network to establish a new communication link in the synchronous TDMA network.

10. A method performed by a synchronized time division multiple access (TDMA) network, comprising:
monitoring, by a processor, transmission of data packets between a plurality of computing devices and a central control system in a synchronized time division multiple access (TDMA) network;
in response to the transmission of the data packets, assigning, by the processor, a communication slot to each of the plurality of computing devices, for synchronizing the central control system with the plurality of computing devices in the synchronized TDMA network;
determining, by the processor, a communication schedule for each of the plurality of computing devices upon establishing the synchronization between the central control system and the plurality of computing devices, wherein the communication schedule defines a direction, computing devices involved, and types of data transactions occurring at a predetermined time frame; and
transmitting, by the processor, a data packet to each of the plurality of computing devices at predefined intervals for aligning a timing parameter of communication between each of the plurality of computing devices and the central control system in the synchronized TDMA network,
wherein the data packet is transmitted via body communicated signals to each of the plurality of computing devices based at least on a device address associated with each of the plurality of computing devices.

11. The method of claim 10, wherein the communication between the plurality of computing devices and the central control system is established using Electro-Quasistatic (EQS) communication on a conductive medium.

12. The method of claim 10, wherein the communication between the plurality of computing devices and the central control system is established using resonant communication on a conductive medium.

13. The method of claim 10, wherein the data packet is transmitted to a corresponding computing device of the plurality of computing devices at a start frame of a predefined time period of occurrence of the communication defined in the communication schedule.

14. The method of claim 10, wherein the types of data transactions comprise data transfers, acknowledgment, handshakes, and communication flow.

15. The method of claim 10, further comprising:
verifying, by the processor, the data packet to be transmitted to the plurality of computing devices in the synchronous TDMA network; and
in response to successful verification of the data packet, transmitting, by the processor, an acknowledgment response to the plurality of computing devices, wherein the acknowledgment response comprises a verification status of the data packet.

16. The method of claim 10, further comprising:
multiplexing, by the processor, the communication slot associated with the plurality of computing devices in the synchronous TDMA network to allow the plurality of computing devices to communicate in the synchronous TDMA network.

17. The method of claim 10, further comprising:
performing, by the processor, a periodic connection survey of each of the plurality of computing devices in the synchronous TDMA network to identify a computing device among the plurality of computing devices that is disconnected from the synchronous TDMA network; and
upon identifying the computing device, establishing, by the processor, a communication link between the identified computing device and the synchronous TDMA network.

18. The method of claim 10, further comprising:
configuring, by the processor, the communication schedule to adjust each of the plurality of computing devices on the synchronous TDMA network to establish a new communication link in the synchronous TDMA network.

19. A computer program product comprising a sequence of instructions stored in a non-transitory computer-readable medium, executable by at least one processor causes the at least one processor to perform a method comprising:
monitoring transmission of data packets between a plurality of computing devices and a central control system in a synchronized time division multiple access (TDMA) network;
in response to the transmission of the data packets, assigning a communication slot to each of the plurality of computing devices, for synchronizing the central control system with the plurality of computing devices in the synchronized TDMA network;
determining a communication schedule for each of the plurality of computing devices upon establishing the synchronization between the central control system and the plurality of computing devices, wherein the communication schedule defines a direction, computing devices involved, and types of data transactions occurring at a predetermined time frame; and
transmitting a data packet to each of the plurality of computing devices at predefined intervals for aligning a timing parameter of communication between each of the plurality of computing devices and the central control system in the synchronized TDMA network,
wherein the data packet is transmitted via body communicated signals to each of the plurality of computing devices based at least on a device address associated with each of the plurality of computing devices.

20. The computer program product of claim 19, wherein the communication between the plurality of computing devices and the central control system is established using Electro-Quasistatic (EQS) communication on a conductive medium.
